(19) United States
(12) Patent Application Publication
(10) Pub. No.: US 2025/0202592 A1
(43) Pub. Date: Jun. 19, 2025

(54) AI-AIDED PDLUT SIMPLIFICATION FOR NON-LINEAR DIGITAL PRE-DISTORTION

(71) Applicant: HUAWEI TECHNOLOGIES CO., LTD., SHENZHEN (CN)

(72) Inventors: Yasser KHALIL, Kanata (CA); Jianhong KE, Kanata (CA); Hongliang LI, Kanata (CA); Xi CHEN, Kanata (CA); Xuefeng TANG, Kanata (CA)

(73) Assignee: HUAWEI TECHNOLOGIES CO., LTD., SHENZHEN (CN)

(21) Appl. No.: 18/538,740

(22) Filed: Dec. 13, 2023

(51) Int. Cl. H04B 10/58

(52) U.S. Cl. CPC H04B 10/58

(57) ABSTRACT

Methods and apparatus are disclosed for generating, transforming, and applying pattern-dependent look-up tables (PDLUTs). Symbol patterns in data transmissions that are susceptible to nonlinear distortions can be pre-compensated using corrections indexed in a PDLUT. However, PDLUTs suffer from trade-offs in complexity and performance. To mitigate these trade-offs, embodiments of the present disclosure provide improvements to PDLUT methods. Some embodiments use a clipping technique to define a quantization of the PDLUT. Some embodiments cascade the PDLUT using a propagation of compensations. Some embodiments reduce the size of the PDLUT according to its symmetry. Some further embodiments unify subsets and complete gaps in the PDLUT using artificial intelligence techniques.

### CROSS-REFERENCE TO RELATED APPLICATIONS

This is the first application filed for the present invention.

### FIELD OF THE INVENTION

The present invention pertains to optical communication networks and in particular to a method and apparatus for correcting nonlinear distortions in data patterns.

### BACKGROUND

The symbols of a data transmission can be susceptible to nonlinear distortions that are introduced by nonlinear phenomena in transmitter or receiver components. These distortions can degrade transmission performance, especially for high-order modulation formats and high baud rates. They can furthermore have a strong dependence on the patterns of symbols in the transmission. This dependence can span a considerable length of symbols in the pattern, which is specified as a memory length, and can arise from interactions between the nonlinear phenomena and frequency responses of transmission components.

To mitigate these pattern-dependent distortions, sample-domain pattern-dependent lookup tables (PDLUTs) have been created and applied. PDLUTs store, for all symbol patterns of a particular memory length, corresponding compensations that can be used to counteract the effects of pattern-dependent distortion. Although PDLUTs can effectively correct distortions, their size and complexity limit implementation. The size of a PDLUT increases exponentially with memory length and the level of quantization of the PDLUT; however, the efficacy of a PDLUT, often measured as the bit error rate (BER), increases as the memory length and quantization level increases. Thus, a trade-off exists between performance and complexity for PDLUTs.

Therefore, there is a need for a method and apparatus for generating and applying PDLUTs that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for generating and applying PDLUTs.

A first aspect of the present disclosure is to provide a method for generating a PDLUT, at a computing device including a processor coupled to tangible, non-transitory processor-readable memory. The method may comprise receiving a sample sequence comprising a plurality of sample symbols (SMBLs) and defining for each SMBL a respective series of X SMBLs. Each series of X SMBLs may have a first end SMBL and a second end SMBL, and may further having a first sub-series of Y SMBLs extending from the first end SMBL toward the second end SMBL and a second sub-series of Z SMBLs extending from the second end SMBL toward the first end SMBL. X, Y, and Z may be whole numbers with Y and Z adding to X plus one. The method may further comprise generating a first sub-PDLUT having a respective plurality of indices and defining for each index of the respective plurality of indices a corresponding compensation. The first sub-PDLUT may be generated by: detecting, for each series of X SMBLs of the sample sequence, a respective first pattern error depending from the corresponding first sub-series of Y SMBLs, all the first pattern errors defining a plurality of first pattern errors; and determining, for each index of the first sub-PDLUT, the corresponding compensation in accordance with the plurality of first pattern errors. The method may further comprise compensating, in accordance with the first sub-PDLUT, the plurality of SMBLs of the sample sequence, and generating a second sub-PDLUT having a respective plurality of indices and defining for each index of the respective plurality of indices a corresponding compensation. The second sub-PDLUT may be generated by: detecting, for each series of X compensated SMBLs of the compensated sample sequence, a respective second pattern error depending from the corresponding second sub-series of Z compensated SMBLs, all the second pattern errors defining a plurality of second pattern errors; and determining, for each index of the second sub-PDLUT, the corresponding compensation in accordance with the plurality of second pattern errors. The method may further comprise appending the first sub-PDLUT and the second sub-PDLUT to form the PDLUT.

In some embodiments of the first aspect, the method may further comprise receiving a true symbol sequence comprising a plurality of true symbols. Each SMBL of the plurality of SMBLs may correspond to a respective true symbol of the plurality of true symbols. Each first pattern error of the plurality of first pattern errors may depend from a difference between the respective series of Y SMBLs and a respective series of Y true symbols, the respective series of Y true symbols corresponding to the respective series of Y SMBLs. Each second pattern error of the plurality of second pattern errors may depend from a difference between the respective series of Z compensated SMBLs and a respective series of Z true symbols, the respective series of Z true symbols corresponding to the respective series of Z compensated SMBLs.

A second aspect of the present disclosure is to provide another method for generating a PDLUT, at a computing device including a processor coupled to tangible, non-transitory processor-readable memory. The PDLUT may have a plurality of indices and define for each index of the plurality of indices a corresponding compensation. The method may comprise receiving a plurality of pattern errors each corresponding to one of a plurality of symbol patterns and determining, for each symbol pattern of the plurality of symbol patterns, a respective error sum and a respective error count each depending from the plurality of pattern errors. All the error sums may define a distribution of error sums, and all the error counts may define a distribution of error counts. The method may further comprise identifying a symmetry defining, for each of the distribution of error sums and the distribution of error counts, a first half and a second half, and inverting additively one of the first half and the second half of the distribution of error sums. The method may further comprise summing, in accordance with the symmetry the first half and the second half of the distribution of error sums to produce a reduced distribution of error sums, and the first half and the second half of the distribution of error counts to produce a reduced distribution of error counts. The method may still further comprise determining, for each index of the plurality of indices, the corresponding compensation in accordance with the reduced distribution of error sums and the reduced distribution of error counts.

In some embodiments of the second aspect, the symmetry may be a midline of the distribution of error sums and the distribution of error counts.

In some embodiments of the second aspect, determining, for each symbol pattern of the plurality of symbol patterns, the respective error sum and the respective error count each depending from the plurality of pattern errors may include: summing, for each symbol pattern of the plurality of symbol patterns, the corresponding pattern errors of the plurality of pattern errors to produce the respective error sum; and counting, for each symbol pattern of the plurality of symbol patterns, the corresponding pattern errors of the plurality of pattern errors to produce the respective error count.

A third aspect of the present disclosure is to provide another method for generating a PDLUT, at a computing device including a processor coupled to tangible, non-transitory processor-readable memory. The PDLUT may have a plurality of indices and defining for each index of the plurality of indices a corresponding compensation. The method may comprise: receiving a plurality of pattern errors; determining, for each index of the plurality of indices, the corresponding compensation in accordance with the plurality of pattern errors; grouping the plurality of indices and the corresponding compensations into a plurality of subsets; and categorizing each subset of the plurality of subsets as one of a complete subset and an incomplete subset. All the compensations of each complete subset may be known, and at least one compensation of each incomplete subset may be unknown. All the complete subsets may define a one or more complete subsets, and all the incomplete subsets may define a one or more incomplete subsets. The method may further comprise: determining one or more base subsets in accordance with the one or more complete subsets; selecting, for each of the one or more incomplete subsets, a respective closest base subset from the one or more base subsets; and determining, for each of the one or more incomplete subsets, each of the at least one unknown compensations in accordance with the respective closest base subset to complete the respective incomplete subset.

In some embodiments of the third aspect, the method may further comprise selecting, for each of the one or more complete subsets, a respective closest base subset, and determining, for each subset of the plurality of subsets, a respective one or more mapping coefficients to map the respective subset to the respective closest base subset. In some of these embodiments, for each subset of the plurality of subsets, the respective one or more mapping coefficients may be a respective scaling coefficient and a respective translation coefficient. In some of these embodiments, for each subset of the plurality of subsets, the respective one or more mapping coefficients may be determined using a linear regression technique.

In some embodiments of the third aspect, the one or more base subsets may be determined using a linear regression technique.

In some embodiments of the third aspect, the PDLUT may have associated thereto a quantization level, and grouping the plurality of indices and the corresponding compensations into the plurality of subsets may result in each subset of the plurality of subsets having grouped therein a number of compensations, the number of compensations corresponding to the quantization level.

In some embodiments of the third aspect, the method may further comprise grouping the one or more complete subsets into a plurality of base groups. In these embodiments, determining the one or more base subsets in accordance with the one or more complete subsets may include determining, for each base group, a respective average of the complete subsets grouped therein.

In some embodiments of the third aspect, the method may further comprise compressing the PDLUT in accordance with principal component analysis to obtain a factor scores matrix, a right singular matrix, and a mean value array each depending from the PDLUT.

A fourth aspect of the present disclosure is to provide another method for generating a PDLUT, at a computing device including a processor coupled to tangible, non-transitory processor-readable memory. The PDLUT may have a plurality of indices and define for each index of the plurality of indices a corresponding compensation. The method may comprise: receiving a plurality of pattern errors; organizing the plurality of pattern errors into an error distribution having associated thereto a distribution mean; and removing one or more pattern errors of the plurality of pattern errors from the error distribution to form a clipped error distribution. The one or more pattern errors may be further than a clipping factor from the distribution mean. The method may further comprise determining a quantization level in accordance with the clipped error distribution; the plurality of indices in accordance with the quantization level; and, for each index of the plurality of indices, the corresponding compensation in accordance with the plurality of pattern errors.

In some embodiments of the fourth aspect, the error distribution may further have associated thereto a standard deviation, and the clipping factor may depend from the standard deviation of the error distribution.

A fifth aspect of the present disclosure is to provide a computing device for generating a PDLUT. The computing device may comprise a processor coupled to tangible, non-transitory processor-readable memory. The memory may have stored thereon instructions to be executed by the processor to implement the method according to any one of the first, second, third, and fourth aspects.

A sixth aspect of the present disclosure is to provide a method for compressing a PDLUT having a plurality of indices and defining for each index of the plurality of indices a corresponding compensation. The method may be performed by a computing device including a processor coupled to tangible, non-transitory processor-readable memory. The method may comprise: receiving the PDLUT; grouping the plurality of indices and the corresponding compensations into a plurality of subsets; and categorizing each subset of the plurality of subsets as one of a complete subset and an incomplete subset. All the compensations of each complete subset may be known, and at least one compensation of each incomplete subset being unknown. All the complete subsets may define a one or more complete subsets, and all the incomplete subsets may define a one or more incomplete subsets. The method may further comprise: determining one or more base subsets in accordance with the one or more complete subsets; selecting, for each of the one or more incomplete subsets, a respective closest base subset from the one or more base subsets; determining, for each of the one or more incomplete subsets, each of the at least one unknown compensations in accordance with the respective closest base subset to complete the respective incomplete subset; selecting, for each of the one or more complete subsets, a respective closest base subset; determining, for each subset of the plurality of subsets, a respective one or more mapping coefficients to map the respective subset to the respective closest base subset; and representing the PDLUT by the respective mapping coefficients of each subset of the plurality of subsets and the one or more base subsets.

A seventh aspect of the present disclosure is to provide another method for compressing a PDLUT having a plurality of indices and defining for each index of the plurality of indices a corresponding compensation. The method may be performed at a computing device including a processor coupled to tangible, non-transitory processor-readable memory. The method may comprise: receiving the PDLUT; grouping the plurality of indices and the corresponding compensations into a plurality of subsets; and categorizing each subset of the plurality of subsets as one of a complete subset and an incomplete subset. All the compensations of each complete subset may be known, and at least one compensation of each incomplete subset may be unknown. All the complete subsets may define a one or more complete subsets, and all the incomplete subsets defining a one or more incomplete subsets. The method may further comprise: determining one or more base subsets in accordance with the one or more complete subsets; selecting, for each of the one or more incomplete subsets, a respective closest base subset from the one or more base subsets; determining, for each of the one or more incomplete subsets, each of the at least one unknown compensations in accordance with the respective closest base subset to complete the respective incomplete subset; determining, for the PDLUT and in accordance with principal component analysis, a factor scores matrix, a right singular matrix, and a mean value array each depending from the PDLUT; and representing the PDLUT by the factor scores matrix, the right singular matrix, and the mean value array.

An eighth aspect of the present disclosure is to provide a computing device for compressing a PDLUT. The computing device may comprise a processor coupled to tangible, non-transitory processor-readable memory. The memory may have stored thereon instructions to be executed by the processor to implement the method according to any one of the sixth and seventh aspects.

A ninth aspect of the present disclosure is to provide a method for pre-compensating an electrical symbol of a sequence of electrical symbols. The method may comprise: accessing a PDLUT having been generated according to any one of the first, second, third, and fourth aspects; identifying, from among the plurality of indices of the PDLUT, a respective target index corresponding to the electrical symbol of the electrical symbol sequence; and applying, to the electrical symbol of the electrical symbol sequence, the compensation of the PDLUT corresponding to the respective target index.

A tenth aspect of the present disclosure is to provide a digital signal processor comprising a non-linear distortion compensation module configured to pre-compensate electrical symbols of a sequence of electrical symbols in accordance with the method of the ninth aspect.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a schematic of a transmission system with PDLUT generation and compensation typical of the prior art.

FIGS. 2A and 2B show examples of cascading a symbol series to generate a PDLUT, in accordance with a method typical of the prior art.

FIG. 3 shows an example of reducing the size of a PDLUT by its symmetry, in accordance with a method typical of the prior art.

FIG. 4A shows an example of a PDLUT with the compensations grouped into subsets, in accordance with a method typical of the prior art.

FIG. 4B shows an example of base subsets for a PDLUT, in accordance with a method typical of the prior art.

FIG. 5 shows schematic for compressing a PDLUT using principal component analysis, in accordance with a method typical of the prior art.

FIG. 6 shows a flowchart of a method for generating a cascaded-PDLUT, in accordance with an embodiment of the present disclosure.

FIG. 7 shows a flowchart of a method for improved semi-PDLUT generation using symmetry, in accordance with an embodiment of the present disclosure.

FIG. 8A shows an example of determining a symmetry for a distribution of error sums, in accordance with an embodiment of the present disclosure.

FIG. 8B shows an example of determining a symmetry for a distribution of error counts, in accordance with an embodiment of the present disclosure.

FIG. 9A shows an example of a typical PDLUT with unknown compensations, where embodiments of the present disclosure may be implemented.

FIG. 9B shows an example of a distribution of symbol errors, where embodiments of the present disclosure may be implemented.

FIG. 10 shows a flowchart of a method for completing unknown compensations in a PDLUT, in accordance with an embodiment of the present disclosure.

FIG. 11A shows examples of base subsets for completing unknown compensations in accordance with an embodiment of the present disclosure.

FIG. 11B shows examples of reconstructed and predicted compensations determined in accordance with an embodiment of the present disclosure for a PDLUT with unknown compensations.

FIG. 11C shows an example of PDLUT wherein unknown compensations have been replaced with predicted compensations determined in accordance with an embodiment of the present disclosure.

FIG. 12 shows a flowchart of a method for improved compression of a PDLUT using principal component analysis, in accordance with an embodiment of the present disclosure.

FIG. 13 shows a flowchart of a method for generating an optimized PDLUT in accordance with an embodiment of the present disclosure.

FIG. 14 shows a flowchart of a method for pre-compensation using a PDLUT, in accordance with an embodiment of the present disclosure.

FIG. 15 shows a schematic of a system for PDLUT generation and pre-compensation, in accordance with embodiments of the present disclosure.

FIG. 16 shows an apparatus for PDLUT generation, compression, and pre-compensation, in accordance with embodiments of the present disclosure.

FIG. 17 shows a schematic of an embodiment of an electronic device that may implement at least part of the methods and features of the present disclosure.

It will be noted that throughout the appended drawings, like features are identified by like reference numerals.

### DETAILED DESCRIPTION

To improve PDLUT symbol compensation, methods and apparatus of the present disclosure are generally directed towards optimizing the generation and compression of PDLUTs. In some embodiments, a cascaded PDLUT may be generated in which a first sub-PDLUT is generated and is used to generate a second sub-PDLUT. In some embodiments, a symmetry operation on symbol errors may be used during PDLUT generation to reduce the size of the PDLUT. In some embodiments, linear regression techniques may be used to complete unknown compensations in a PDLUT and to reduce the size of the PDLUT. In some further embodiments, the quantization level of a PDLUT may be determined from a clipped error distribution to improve the performance of the PDLUT. In some still further embodiments, PDLUTs generated by the preceding methods may be used in methods and apparatus to pre-compensate transmission symbols.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. The terms of the following sets may be used interchangeably throughout the disclosure: “correction” and “compensation”; “transmission symbols”, “ideal symbols”, and “true symbols”; “distortion” and “error”; “received symbols”, “sample symbols”, and “distorted symbols”; “received sequence” and “sample sequence”; and compensation “subset” and “curve”.

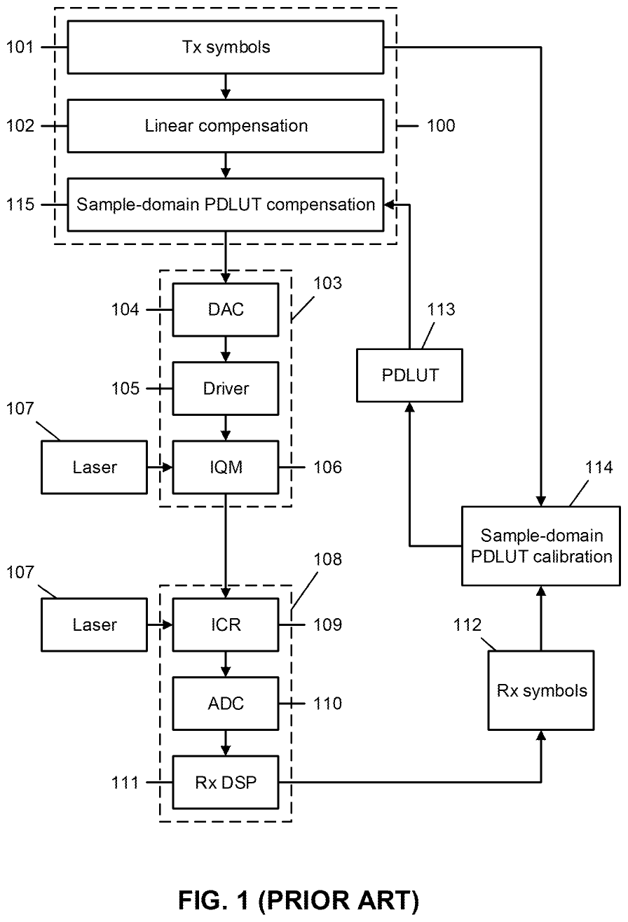

FIG. 1 shows a schematic of a data transmission system typical of the prior art wherein PDLUTs may be generated and applied. The data transmission system is depicted for optical transmissions; however, the transmission channel could also be wired or wireless. At a transmitter digital signal processor (DSP) 100, transmission symbols 101 (Tx, also referred to as “true symbols” or “ideal symbols”) are generated in a sequence to carry the information of the desired data transmission. Prior to being sent, linear compensation 102 is applied to the transmission symbols 101 to pre-compensate linear distortions, such as with the use of a finite-impulse response filter. Transmitter components 103 convert the transmission symbols 101 from being an electrical signal to an optical signal. These components may include a digital-to-analog converter (DAC) 104, a modulator driver 105, an in-phase quadrature modulator (IQM) 106, and other components such as an RF amplifier. Each of the transmitter components 103 may introduce nonlinear distortions to the optical signal. The transmitter components 103 may be used in conjunction with a laser 107 that serves as a light source for the optical signal. The transmission symbols 101 may be encoded in the light through various modulation formats and may impart a quantization level L to the transmission. Modulation formats may include, for example, X and Y polarization quadrature (XI, XQ, YI, YQ) and 16 or 64 quadrature amplitude modulation. Receiver components 108 receive the optical signal after it has been transmitted and convert the optical signal back into an electrical signal. The receiver components 108 may include an integrated coherent receiver (ICR) 109, an analog-to-digital converter (ADC) 110, and a receiver DSP 111. Each of the receiver components 108 may also introduce nonlinear distortions to the optical signal. The receiver components 108 may be used in conjunction with another laser 107 for detecting the optical signal.

The signal received and converted by the receiver components 108 defines received symbols 112 (Rx, also referred to as “distorted symbols” or “sample symbols”) that correspond to the transmission symbols 101 and that follow a received sequence (i.e., a sample sequence). The received symbols 112 are then compared against the transmission symbols 101, which may be sent through a separate error-free channel, to generate a PDLUT 113 through sample-domain PDLUT calibration 114. Each compensation entry of the PDLUT 113 is be calculated as the average error (i.e., the “pattern error”) for a respective pattern of symbols (i.e., “a symbol pattern”) in the transmission of a specified memory length N. Each symbol pattern may be present in the signal or sequence of symbols according to a particular distribution, and so a distribution of errors for each symbol pattern may occur. The number of compensations stored in the PDLUT 113 (i.e., the PLDUT size, M) is determined by L^{N}. The position of each compensation in the PDLUT 113 is defined by an index.

Once the PDLUT 113 is generated it may be applied towards pre-compensating future data transmissions. After linear compensation, transmission symbols 101 may be pre-compensated for nonlinear distortions through sample-domain PDLUT compensation 115.

There are various methods of the prior art for reducing the size of a PDLUT 113, but these typically have trade-offs between PDLUT size and performance.

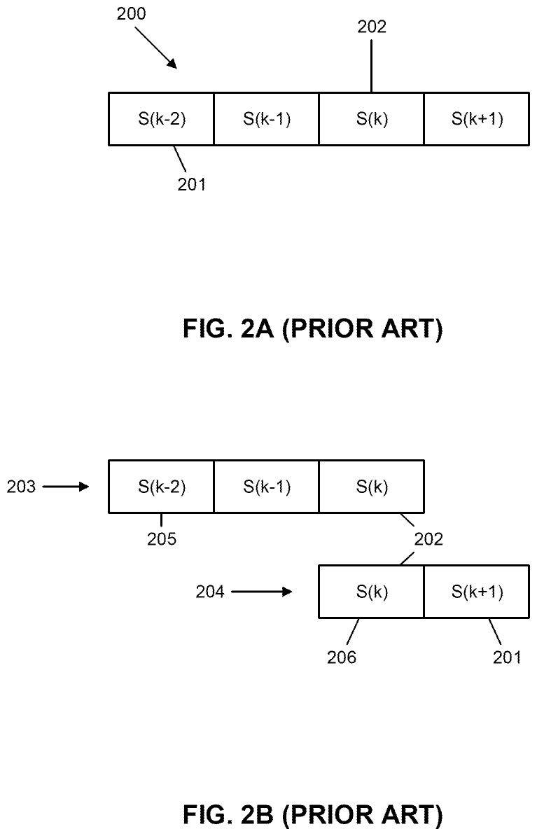

FIGS. 2A and 2B show an example for cascading a PDLUT 113 to reduce its size, in accordance with a method of the prior art. FIG. 2A shows an example of a series 200 of four symbols 201. The series may exhibit various symbol patterns having a memory length of four. The series 200 is centered at symbol S(k) 202, the under-correct symbol. In this example, if a PDLUT 113 were to be generated using the series 200 and if the quantization level were to be eight, the PDLUT 113 would have a size of 4096. FIG. 2B shows an example of cascading the series 200 to produce two sub-series of symbols. The original series 200 of four symbols 201 is cascaded into a first sub-series 203 of three symbols 201 (memory length of three) and a second sub-series 204 of two symbols 201 (memory length of two). Each sub-series shares the under-correct symbol S(k) 202. The first sub-series 203 extends from the first end symbol 205 (S(k−2)) of the series 200 to the under-correct symbol S(k) 202, and the second sub-series 204 extends from the under-correct symbol S(k) 202 to the second end symbol 206 (S(k+1)) of the symbol pattern 200. To generate a PDLUT 113, two sub-PDLUTs are first generated, each corresponding to one of the sub-series. For a quantization level of eight, the first sub-PDLUT would have a size of 512 and the second sub-PDLUT would have a size of 64. Appending the first sub-PDLUT and the second sub-PDLUT to form the PDLUT 113, would lead to a total size of 576, which is smaller than the size of the PDLUT 113 generated in reference to FIG. 2A.

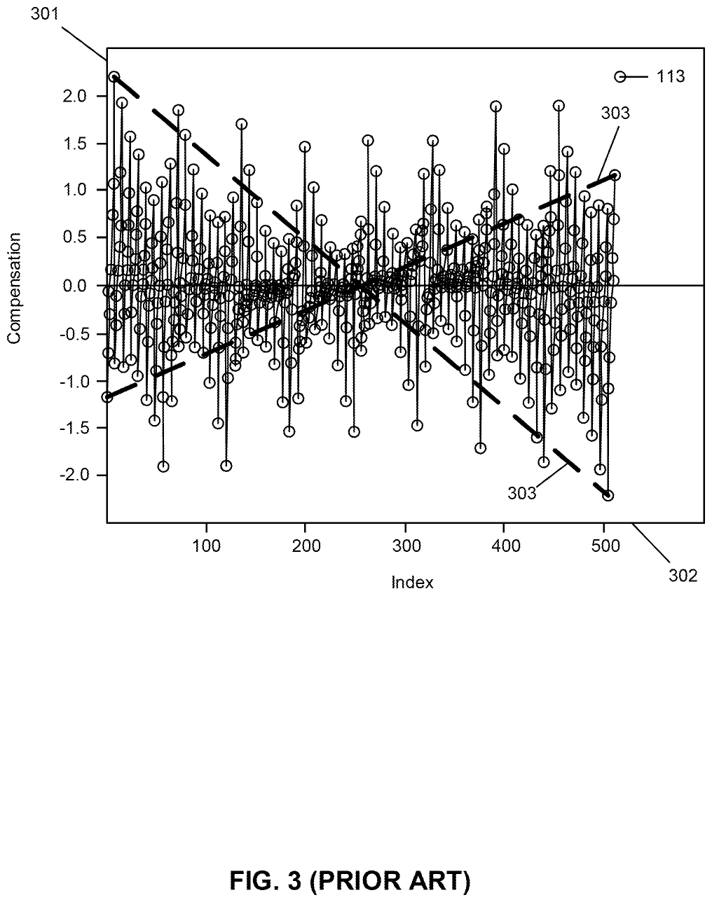

FIG. 3 shows an example of reducing the size of a PDLUT 113 to produce a semi-PDLUT by finding a symmetry in the PDLUT 113, in accordance with a method of the prior art. FIG. 3 shows a plot of the compensations 301 of the PDLUT 113 by their index 302. The initial size of the PDLUT 113 is 512 and is approximately symmetrical about the center point (index value 256). The dashed lines 303 indicate symmetrical points of the PDLUT 113. To reduce the size of the PDLUT 113, one half of the PDLUT 113 is disregarded, in accordance with the symmetry, and the other half is used to reconstruct the one half. In this way the size of the PDLUT 113 can be reduced by half.

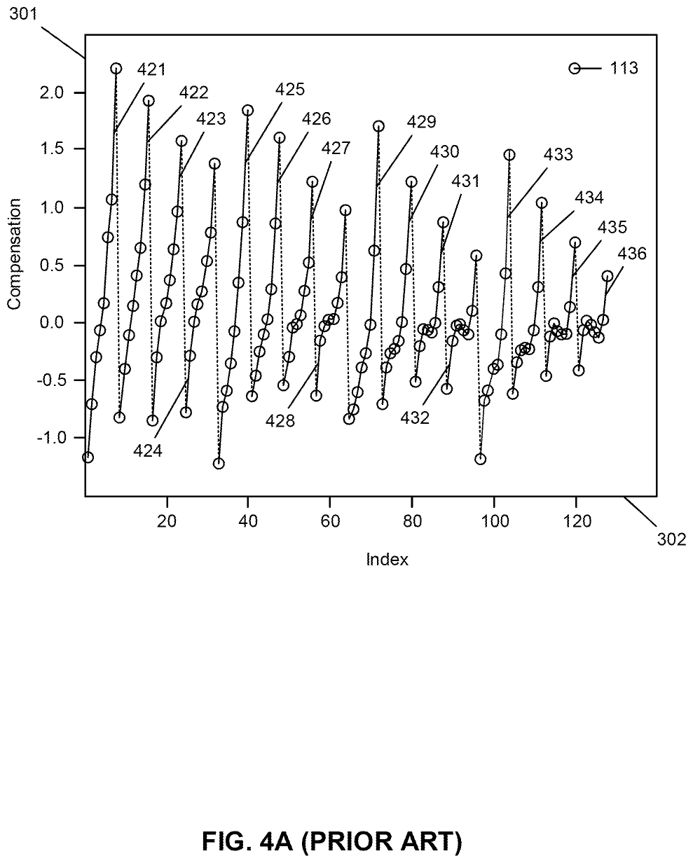

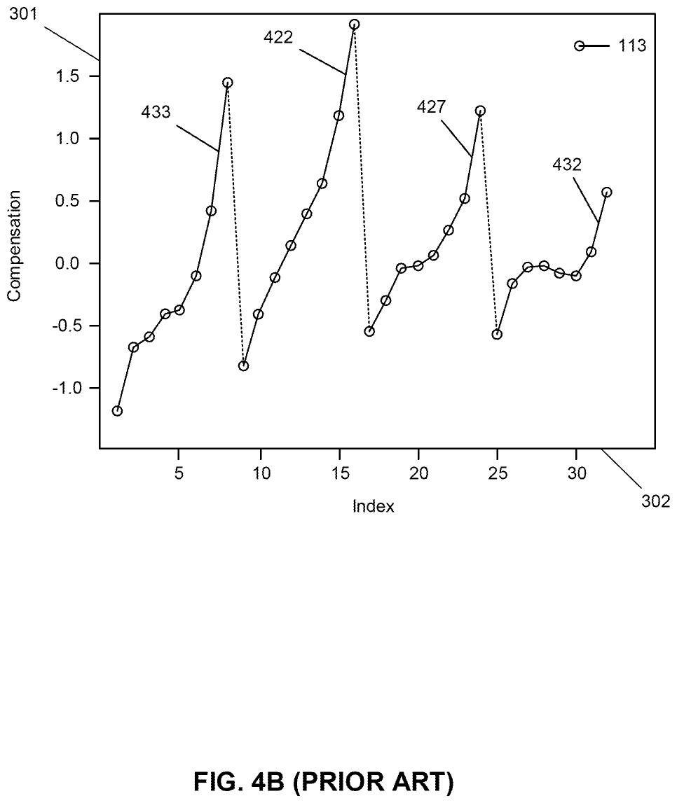

FIGS. 4A and 4B show an example of reducing the size of a PDLUT 113 by using artificial intelligence (AI) to unify the compensations 301 (i.e., “AI unification”), in accordance with a method of the prior art. FIG. 4A shows a plot of the compensations 301 of the PDLUT 113 by their index 302. In this example, the size of the PDLUT 113 has already been reduced according to a point of symmetry. The compensations 301 of FIG. 4A are grouped into subsets (also referred to as “curves”), each containing L compensations and shown with a solid line. Dotted lines indicate the separation between subsets. To reduce the size of the PDLUT 113, the subsets are further grouped into a number of clusters. In this example, four clusters are used. For each cluster, a base subset is then selected from among all the subsets of that cluster. In the example, subsets 422, 427, 432, and 433 are selected and the remaining subsets are grouped into clusters as indicated by Table 1. FIG. 4B shows a plot of the compensations 301 of each of the base subsets, reordered. Mapping coefficients are then determined for each subset of a cluster for mapping that subset to the base subset of the cluster. In this example, two mapping coefficients a and b are used such that a cluster subset is represented by the base subset×a+b. Coefficient a is a scaling coefficient, and coefficient b is a translation coefficient. Table 1 shows the mapping coefficients for mapping each cluster subset to the respective base subset. With this method, only two pieces of information and the base subset are needed to reconstruct a given subset, effectively reducing the overall size of the PDLUT 113. Grouping the clusters into subsets, selecting a base subset for each cluster, and mapping the cluster subsets to the respective base subset may be one using AI techniques, such as linear regression modelling.

TABLE 1
Clusters and mapping coefficients for
the PDLUT subsets of FIGs. 4A and 4B.

| Cluster | Base Subset | Cluster Subsets | a | b |
|---|---|---|---|---|
| 1 | 433 | 425 | 0.8511433 | −0.075676 |
| | | 429 | 0.8077597 | −0.189006 |
| 2 | 422 | 421 | 1.2105033 | −0.204368 |
| | | 423 | 0.844589 | 0.0073529 |
| | | 424 | 0.7399695 | −0.016422 |
| | | 426 | 0.8256738 | −0.141373 |
| 3 | 427 | 428 | 0.8400593 | −0.030283 |
| | | 430 | 1.0916813 | −0.169879 |
| | | 431 | 0.7406947 | −0.080606 |
| | | 434 | 0.9219141 | −0.182062 |
| 4 | 432 | 435 | 1.0211972 | 0.0321379 |
| | | 436 | 0.7057813 | −0.009268 |

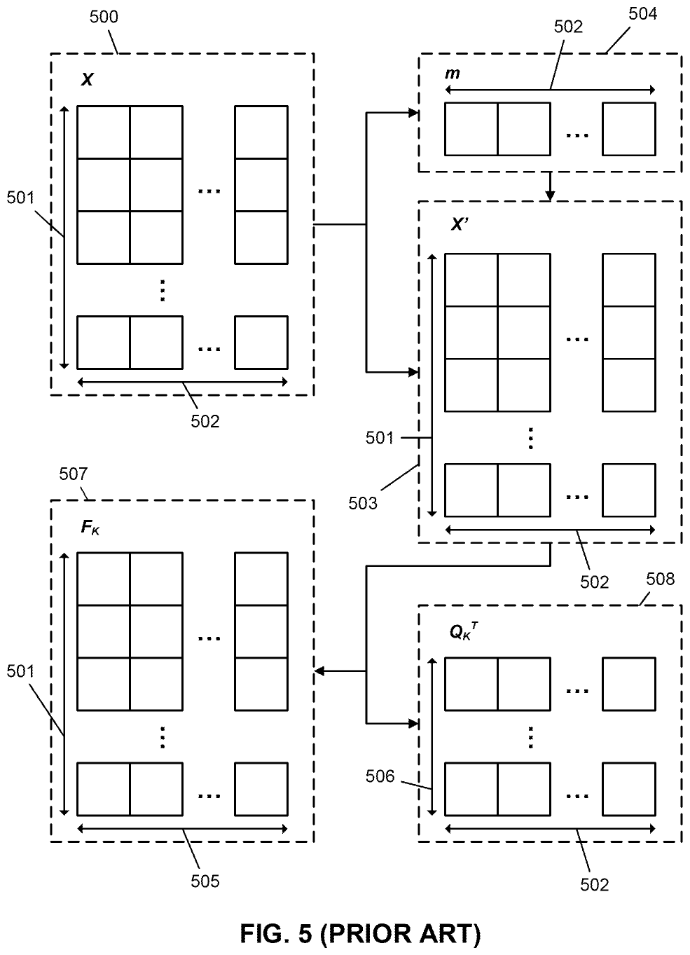

FIG. 5 shows a schematic of a method of the prior art for compressing a PDLUT 113 using principal component analysis (PCA) to reduce the size of the PDLUT 113. First, the compensations 301 of the PDLUT 113 are arranged into a matrix X 500 having dimensions I 501 and J 502, where I 501 equals L^{N-1} and J 502 equals L. Then the matrix X 500 is centered by subtracting the mean of each column from the respective column to generate matrix X′ 503, which retains dimensions I 501 and J 502. The means of each column are stored in a mean value array, matrix m 504 with dimensions 1×J 502. With singular value decomposition, matrix X′ 503 can be decomposed according to:

$${X}^{′} = P Δ {Q}^{T} \qquad ( 1 )$$

where P is the left singular matrix (I 501×I 501), Δ is the singular values diagonal matrix (I 501×J 502), and Q^{T} is the transposed right singular matrix (J 502×J 502). A factor scores matrix F can be used to represent matrices P and Δ according to:

$$F = P Δ . \qquad ( 2 )$$

Equation 1 can then be re-written as:

$${X}^{′} = {FQ}^{T} . \qquad ( 3 )$$

The dimensions of the matrix X′ 503 can then be reduced by retaining K principal components from matrices F and Q^{T}, i.e., the first K columns 505 of matrix F and the first K rows 506 of matrix Q^{T} are kept to obtain F_{K} 507 and Q^{T}_{K} 508, respectively. The reduced matrix X′ 503 can be approximated by:

$${X}^{′} \approx {F}_{K} {Q}_{K}^{T} . \qquad ( 4 )$$

The quantity K determines the degree of compression applied to matrix X′503; for example, if K=L, no compression is applied, and if K=1, a maximum amount of compression is applied. The entries xᵢⱼ of matrix X 500 can be reconstructed according to:

$${x}_{i j} \approx {\sum }_{k = 1}^{K} {f}_{i , k} \times {q}_{k , j}^{T} + {m}_{j} \qquad ( 5 )$$

where f_{i,k} are entries of matrix F_{K} 505, q_{k,j} are entries of matrix Q^{T}_{K} 506, and mⱼ are entries of matrix m 504. Matrices F_{K} 505 and Q_{T}^{K} 506 can be iteratively compressed to further reduce the PDLUT 113 size.

The methods of the prior art described hereinabove for reducing the size of a PDLUT 113 may sacrifice performance. Embodiments of the present disclosure reduce the size of the PDLUT 113 while maintaining or improving performance. In some embodiments, the performance of the PDLUT 113 is improved by filling gaps in the distribution of symbol patterns used to generate the PDLUT 113.

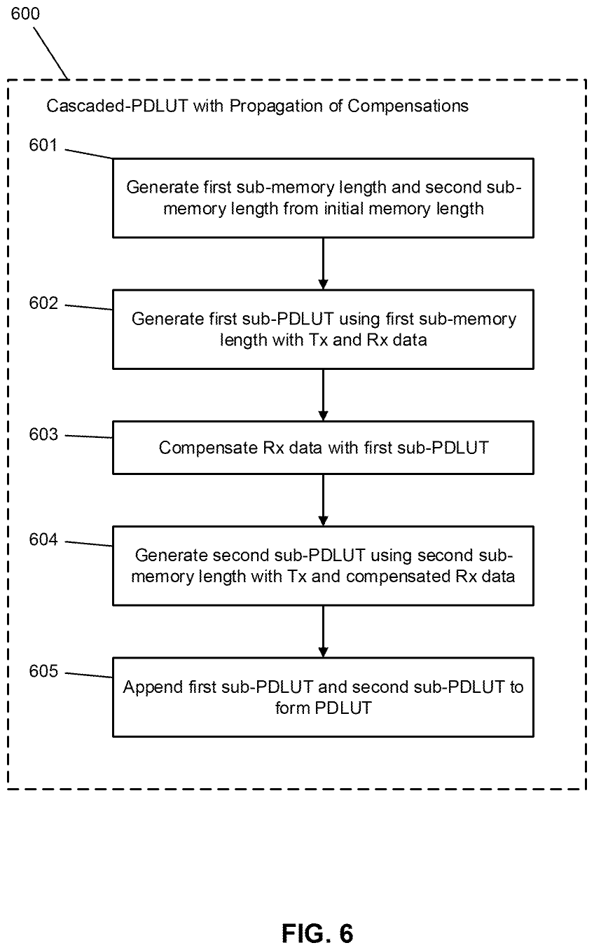

FIG. 6 shows a flowchart of a method 600 for generating a cascaded-PDLUT with a propagation of compensations, in accordance with an embodiment of the present disclosure. At action 601, the desired memory length N for the PDLUT 113 may be transformed into two sub-lengths, a first sub-memory length and a second sub-memory length. For each symbol of a sample sequence that is received for generating the PDLUT 113, the memory length N may define a respective series of X symbols that includes the respective symbol itself. In other words, the memory length may define a moving window that comprises X symbols and that is used to detect errors in the symbol pattern at each symbol of the sample sequence. The number of symbols X in the series may typically equal N. The X symbols in each series of the sample sequence may typically be adjacent to one another. Each series of X symbols may have a first end symbol and a second end symbol. In transforming the memory length into two sub-lengths, two new sub-series of symbols for each series of X symbols may be defined. A first sub-series of Y symbols may extend from the first end symbol towards the second end symbol. A second sub-series of Z symbols may extend from the second end symbol towards the first end symbol. X, Y, and Z are whole numbers, and Y and Z may add to X plus one. In other words, the two sub-memory lengths each define a respective moving window that is used to detect a respective error in the symbol pattern of each symbol of the sample sequence, with one respective error corresponding the preceding symbol pattern and the other respective error corresponding to the succeeding symbol pattern.

At action 602, a first sub-PDLUT may be generated. For each series of X symbols in the sample sequence, a respective first pattern error may be detected using the corresponding sub-series of Y symbols. Each first pattern error may be detected by determining the difference between the respective series of Y symbols of the sample sequence (i.e., the Rx symbols) and a corresponding series of Y symbols of a true sample sequence (i.e., the Tx symbols). All of the first pattern errors may then be used to determine the compensations of the first sub-PDLUT.

At action 603, the first sub-PDLUT may be used to compensate the symbols of the sample sequence to produce a compensated sample sequence.

A second sub-PDLUT may then be generated using each sub-series of Z symbols in the compensated sample sequence. In this way, the method 600 may involve a propagation of compensations in generating the cascaded-PDLUT.

At action 604, the second sub-PDLUT may be generated. For each series of X symbols in the compensated sample sequence, a respective second pattern error may be detected using the corresponding sub-series of Z symbols. Each second pattern error may be detected by determining the difference between the respective series of Z symbols of the compensated sample sequence (i.e., the compensated Rx symbols) and a corresponding series of Z symbols of the true sample sequence (i.e., the Tx symbols). All of the second pattern errors may then be used to determine the compensations of the second sub-PDLUT.

At action 605, the first sub-PDLUT and the second sub-PDLUT may be appended to form the cascaded-PDLUT.

Cascading a PDLUT 113 with the use of propagation of compensations may reduce the size of the PDLUT 113 while improving the performance over other methods for cascading the PDLUT 113 without the use of propagation of compensations. Table 2 shows the BER as an indicator of performance and the table size for PDLUTs generated according to different methods. Each PDLUT in Table 2 has a quantization level of eight and a memory length of five, which was transformed into two equal sub-lengths of three when cascaded.

TABLE 2
Performance and size for PDLUTs generated according
to different methods for cascading a PDLUT.

| Cascading Method | BER | Size |
|---|---|---|
| None | 0.0064408 | 32,768 |
| Without propagation of | 0.0050354 | 1024 |
| compensations | | |
| With propagation of | 0.0037771 | 1024 |
| compensations | | |

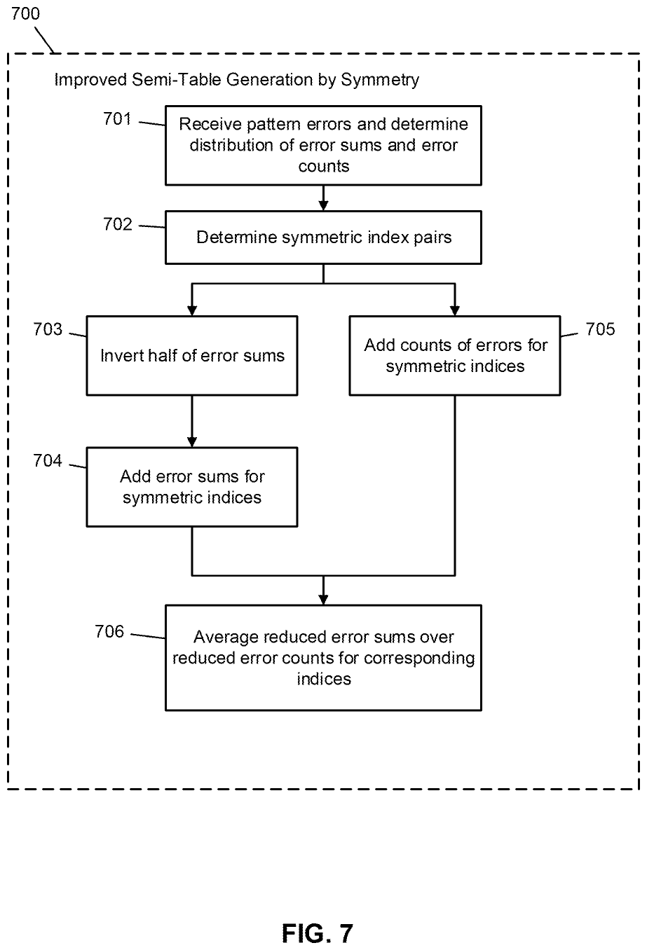

FIG. 7 shows a flowchart of a method 700 for improved generation of a semi-PDLUT using symmetry, in accordance with an embodiment of the present disclosure. At action 701, pattern errors and their distribution may be obtained from a sample sequence of symbols. Each pattern error may correspond to a distinct symbol pattern in the sample sequence and to an index 302 of the PDLUT that is being generated. Further at action 701, for each symbol pattern in the sample sequence, a respective error sum and a respective error count depending from all the pattern errors for that symbol pattern may be determined. Each error sum may be determined by summing the corresponding pattern errors, and each error count may be determined by counting the corresponding pattern errors. At action 702, pairs of indices that are equidistant from the middle indices of the PDLUT may be determined. The middle indices of the PDLUT may define a symmetry in the PDLUT. For example, for a quantization level of eight and a memory length of 3, the PDLUT would have a size of 512; then, index values 256 and 257 would define a midline of symmetry within the PDLUT. All the first halves of each index pair may define a first half of the distributions of error sums and error counts, and all the second halves of each index pair may define a second half of the distributions of error sums and error counts.

At action 703, one of the first half or the second half of the distribution of error sums may be additively inverted. In other words, the error sums for that half of the distribution may be multiplied by negative one. At action 704, the first half and the second half of the distribution of error sums may be added together according to the pairs of symmetric indices to form a reduced distribution of error sums, having half as many indices. At action 705, the first half and the second half of the distribution of error counts may be added together according to the pairs of symmetric indices to form a reduced distribution of error counts, having half as many indices.

At action 706, the error sum for each index 302 of the reduced distribution of error sums may be averaged by the corresponding error count of the reduced distribution of error counts to determine the compensations for the semi-PDLUT. The PDLUT may be constructed from the semi-PDLUT in accordance with the symmetry.

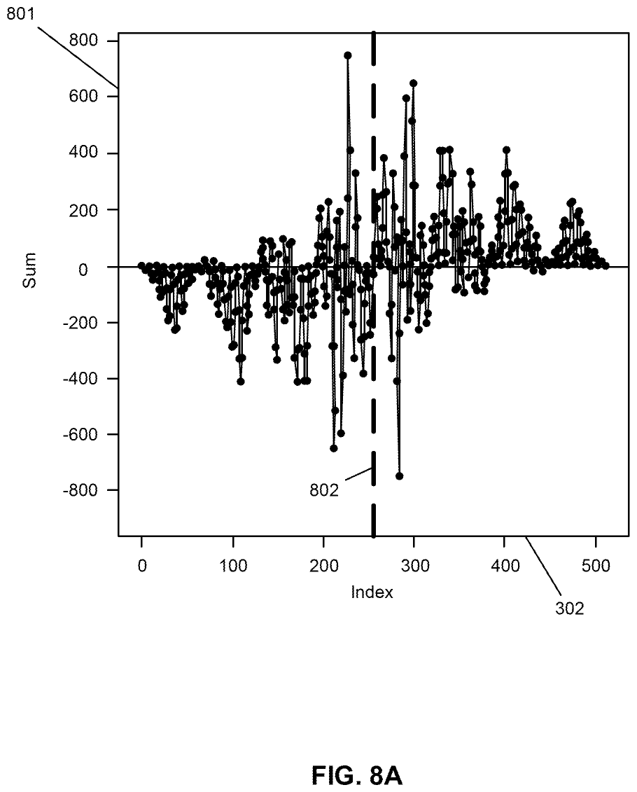

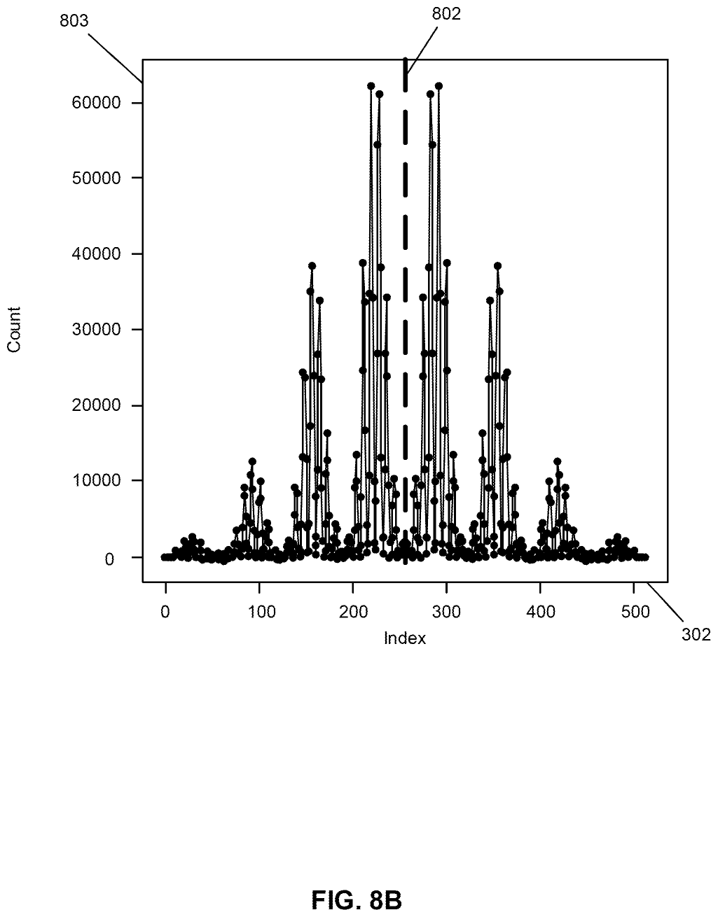

FIGS. 8A and 8B show an example of semi-PDLUT generation in accordance with the method of FIG. 7. FIG. 8A shows the error sum 801 for each index 302 of a distribution of error sums. FIG. 8A further shows a symmetry midline 802 of the distribution of error sums, which bisects the distribution and defines its first half and its second half. FIG. 8B shows the error count 803 for each index 302 of a distribution of error counts corresponding to the distribution of error sums shown in FIG. 8A. FIG. 8B further shows the symmetry midline 802, which also bisects the distribution of error counts and defines its first and its second half.

Reducing a PDLUT 113 to a semi-PDLUT through the use of symmetry may reduce the size of the PDLUT 113. The method of FIG. 7 may further improve the performance of the table when compared to other methods for semi-PDLUT generation. Table 3 shows the BER as an indicator of performance and the table size for semi-PDLUTs generated according to methods discussed in relation to FIG. 7 (improved method) and FIG. 3 (prior art method). The differences in performance between the two methods become more noticeable as the quantization level increases. Each PDLUT in Table 2 has been cascaded using the method discussed in relation to FIG. 6, such that the PDLUT's memory length of five has been transformed into two equal sub-lengths of three.

TABLE 3
Performance and size for semi-PDLUTs generated
according to different methods for cascading a PDLUT.

| Quantization | BER | | |
|---|---|---|---|
| Level | Prior Art Method | Improved Method | Size |
| 8 | 0.0037870 | 0.0037771 | 512 |
| 10 | 0.0036400 | 0.0036302 | 512 |
| 12 | 0.0035738 | 0.0035470 | 512 |
| 14 | 0.0035321 | 0.0035025 | 512 |

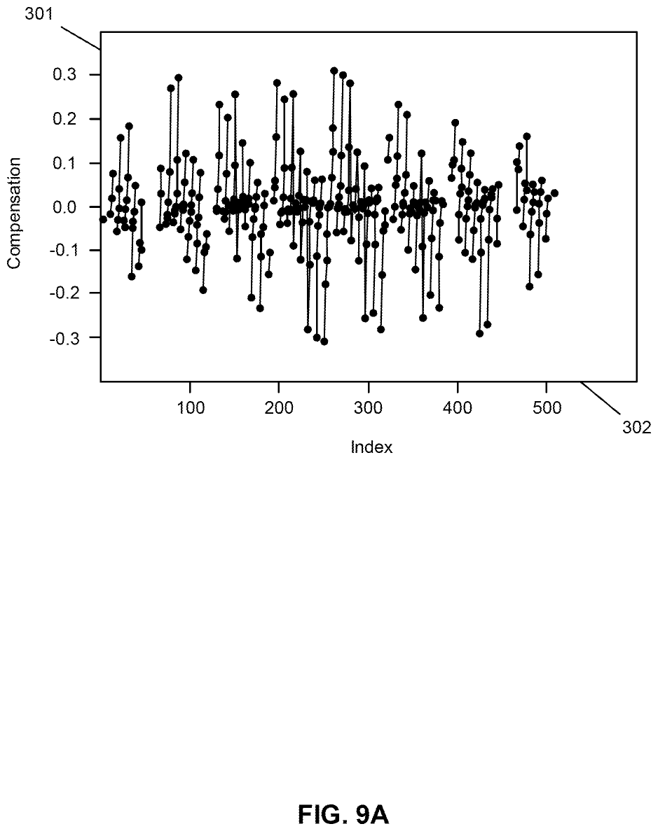

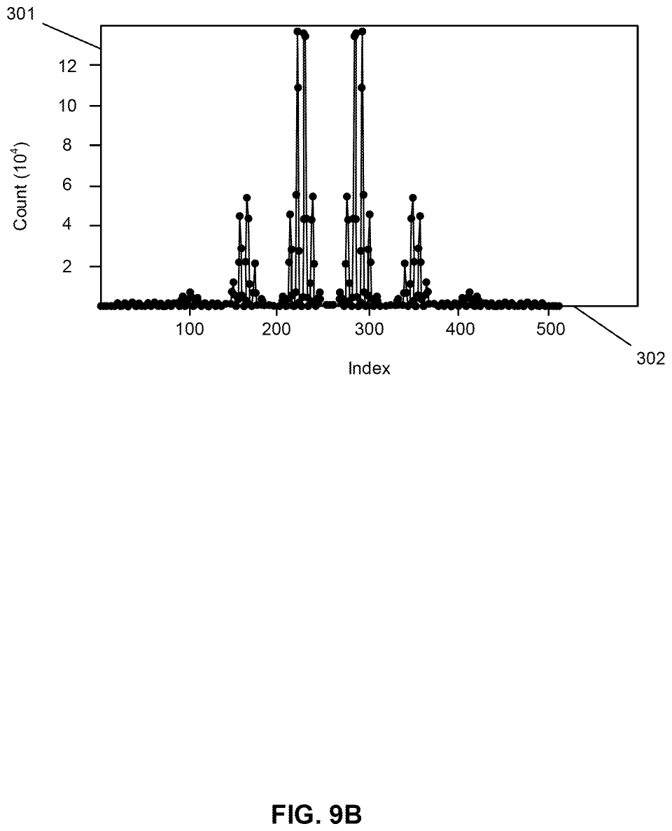

FIG. 9A shows an example of compensations 301 for indices 302 of a PDLUT 113 obtained from a typical sample sequence. In FIG. 9A, some indices 302 of the PDLUT 113 lack compensations 301 (i.e., the compensations 301 are “unknown”). This may arise when some symbol patterns are absent from the sample sequence and its distribution of symbol patterns. FIG. 9B shows a distribution of symbol patterns by a count 803 of their respective errors for the sample sequence used to generate the PDLUT 113 of FIG. 9A. In FIG. 9B, the count 803 is zero for many indices 302, indicating the absence of the corresponding symbol patterns in the sample sequence.

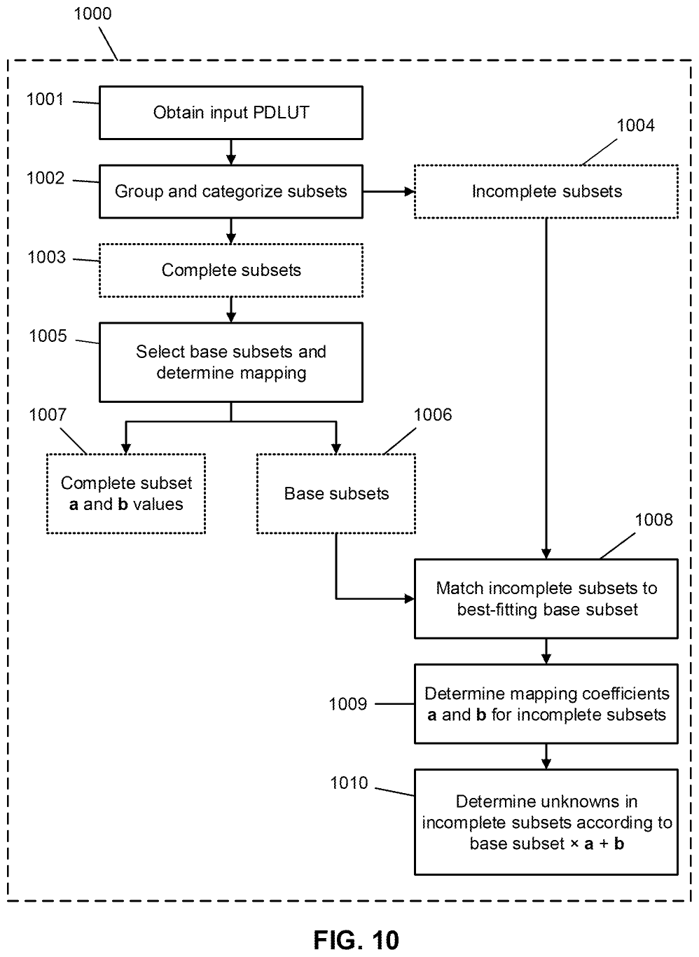

FIG. 10 shows a flowchart of a method 1000 for determining unknown compensations 301 in a PDLUT 113 to improve the performance of the PDLUT 113, in accordance with an embodiment of the present disclosure. At action 1001, an input PDLUT 113 may be obtained. This may include receiving pattern errors from a sample sequence and determining compensations 301 for the input PDLUT 113 from the pattern errors. At action 1002, the compensations 301 of the input PDLUT 113 may be grouped into subsets, with the compensations 301 corresponding to each L grouping of indices 302 forming a subset. Complete subsets 1003 and incomplete subsets 1004 may be categorized from among the subsets. Each complete subset 1003 may have all of the respective compensations 301 known, whereas each incomplete subset 1004 may have at least one compensation 301 unknown.

At action 1005, one or more base subsets 1006 may be selected from among the complete subsets 1003. The base subsets 1006 may be determined through an AI method and may involve using a linear regression technique. Alternatively, each base subset 1006 may be an average of a group of one or more base subsets (i.e., a “base group”). At action 1005, mapping coefficients 1007 may further be determined for mapping each complete subset 1003 to one of the base subsets 1006. The mapping coefficients 1007 may include two mapping coefficients 1007 a and b that may be used to represent a complete subset 1003 by base subset×a+b. Coefficient a may be a scaling coefficient, and coefficient b may be a translation coefficient. The mapping coefficients 1007 may be determined through an AI method and may involve using a linear regression technique.

At action 1008, for each of the incomplete subsets 1004, a base subset 1006 may be selected that is the closest or best-fitting to the respective incomplete subset 1004. Alternatively, a portion of a base subset 1006 may be selected for each of the incomplete subsets 1004, based on the known compensations of the respective incomplete subset 1004. The closest base subset 1006 for each incomplete subset 1004 may be determined through an AI method and may involve linear regression techniques. At action 1009, mapping coefficients 1007 may be determined for mapping each of the incomplete subsets 1004 to the respective closest base subset 1006. The mapping coefficients 1007 may include two mapping coefficients 1007 a and b that may be used to represent an incomplete subset 1004 by base subset×a+b. Coefficient a may be a scaling coefficient, and coefficient b may be a translation coefficient. The mapping coefficients 1007 may be determined through an AI method and may involve using a linear regression technique. At action 1010, the unknown compensations for each incomplete subset 1004 may be determined by reconstructing the respective incomplete subset with the respective closest base subset 1006 and the respective mapping coefficients 1007. Therefore, with the method of FIG. 10, unknown compensations of a PDLUT 113 can be determined to improve the performance of the PDLUT 113, and mapping coefficients 1007 and base subsets 1006 can be determined to reduce the size of the PDLUT 113. Altogether, the method of FIG. 10 may be referred to as improved AI unification.

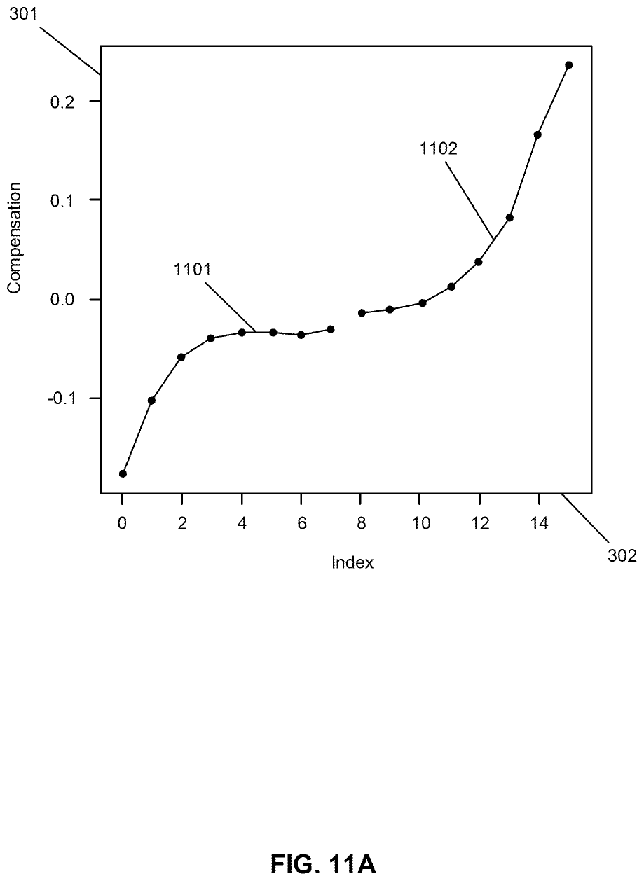

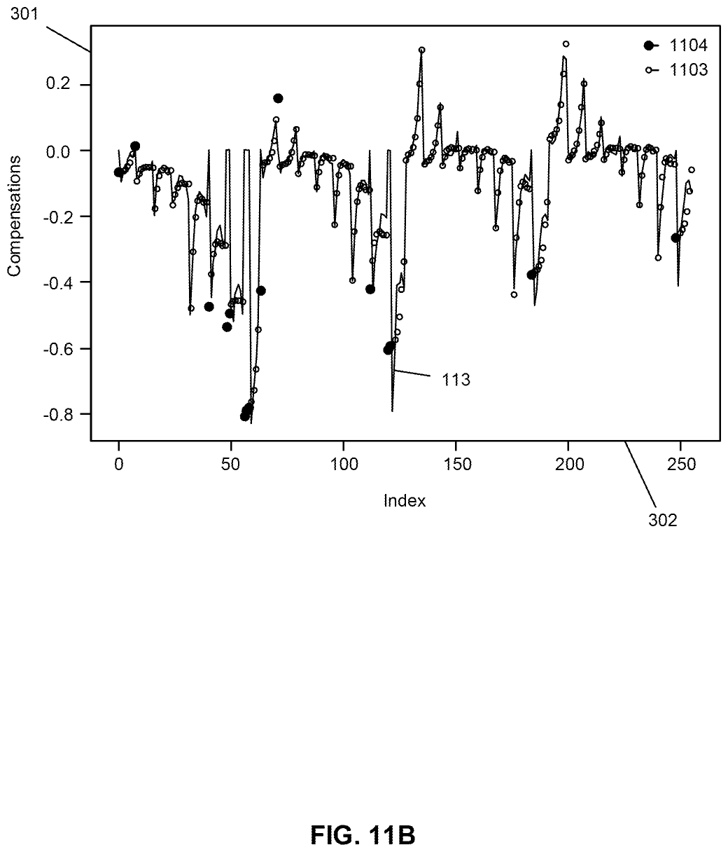

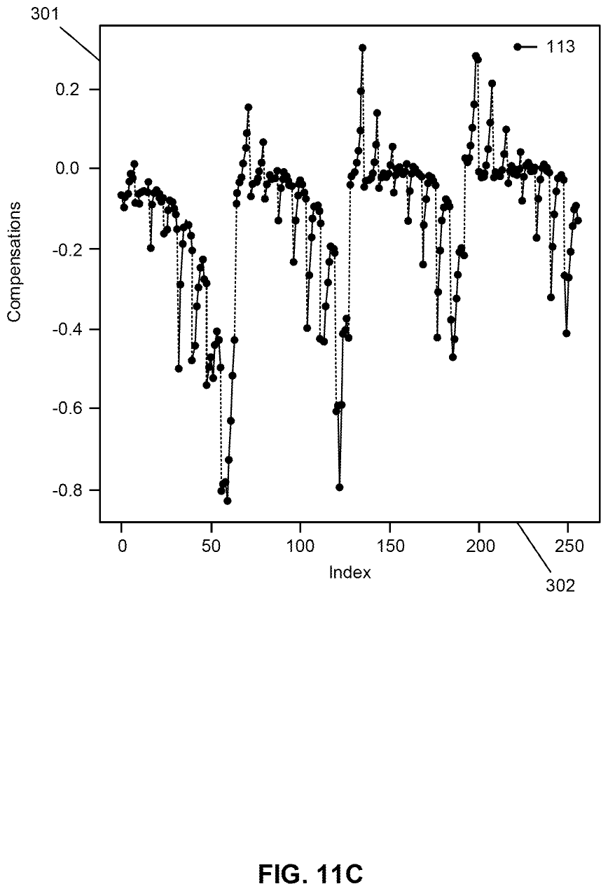

FIGS. 11A, 11B, and 11C show an example for determining unknown compensations of a PDLUT 113 in accordance with the method of FIG. 10. FIG. 11A shows the compensations 301 by index 302 for two base subsets (base subset 1101 and base subset 1102) that are used to determine the unknown compensations of the example. FIG. 11B shows the compensations 301 of a PDLUT 113 by index 302 and reconstructed compensations 1103 (open circles) that have each been determined for the PDLUT 113 in accordance with base subset 1101 or base subset 1102 of FIG. 11A. FIG. 11B further shows predicted compensations 1104 (closed circles) from among the reconstructed compensation 1103 that correspond to unknown compensations in the PDLUT 113. The predicted compensations 1104 may be used to replace the unknown compensations in the PDLUT 113. FIG. 11C shows the PDLUT 113 with the predicted compensations 1104 replacing the unknown compensations, such that all of the compensations 301 are known and each subset is complete (subsets are indicated by the solid lines and connected by the dotted lines).

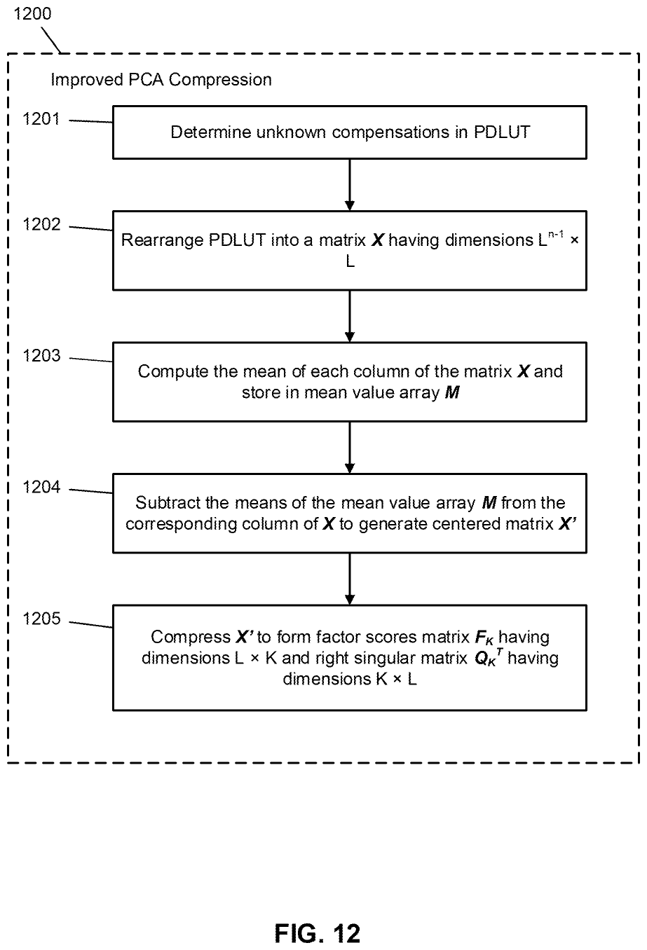

FIG. 12 shows a flowchart of a method 1200 for an improved compression of a PDLUT 113 using PCA, in accordance with an embodiment of the present disclosure. At action 1201, the method 1000 described in relation to FIG. 10 may be performed, in whole or partially, to determine any unknown compensations in the PDLUT 113. At action 1202, the PDLUT 113 may be rearranged into a matrix X 500 having dimensions I 501 and J 502, where I 501 equals L^{N-1} and J 502 equals L. At action 1203, the mean of each column of the matrix X 500 may be computed and stored in a mean value array, matrix m 504 with dimensions 1×J 502. At action 1204, the matrix X 500 may be centered by subtracting the mean of each column from the respective column to generate matrix X′503, which retains dimensions I 501 and J 502. At action 1205, matrix X′ 503 can be decomposed according to Equation 4 to obtain a reduced factor scores matrix F_{K} 507, having dimensions L and K, and a reduced, transposed right singular matrix Q^{T}_{K} 508, having dimensions K and L. The method 1200 of FIG. 12 may be iteratively applied to the matrices F_{K} 505 and Q^{T}_{K} 506, and matrices depending therefrom, to further compress the PDLUT 113.

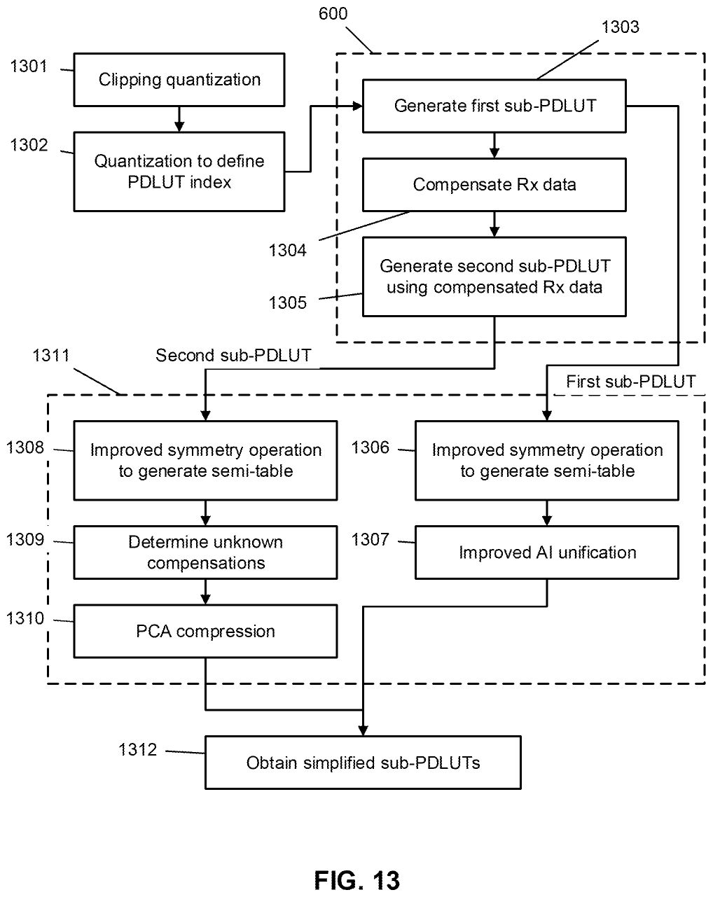

FIG. 13 shows a flowchart of a method for generating an optimized PDLUT 113 in accordance with embodiments of the present disclosure. At action 1301, a clipping quantization is performed to determine a quantization level for the PDLUT 113. In the clipping quantization, pattern errors obtained from a sample sequence may be organized into an error distribution according to the number of occurrences of each pattern error. The error distribution may then have a distribution mean representing the most commonly occurring pattern error. The error distribution may be clipped by removing one or more pattern errors from the error distribution to form a clipped error distribution. The pattern errors that are removed may be further than a pre-determined clipping factor from the distribution mean in the error distribution. The quantization level may then be determined for the PDLUT 113 in accordance with the clipped error distribution. In some embodiments, the clipping factor may be a standard deviation of the error distribution or may depend therefrom. At action 1302, the indices 302 of the PDLUT 113 are determined (i.e., quantization) in accordance with the quantization level determined at action 1301. Table 4 shows a comparison in performance, as indicated by a BER, for PDLUTs 113 generated using two different methods for quantization, clipping quantization and a maximum-minimum quantization typical of the prior art. Each PDLUT 113 in Table 4 has been cascaded using the method discussed in relation to FIG. 6, such that the PDLUT's memory length of five has been transformed into two equal sub-lengths of three.

TABLE 4

| PDLUT performance and size for | | |
|---|---|---|
| different quantization methods. | | |
| Quantization Method | BER | Size |
| Maximum-minimum | 0.0050967 | 1024 |
| Clipping | 0.0050354 | 1024 |

At action 1303 of FIG. 13, a first sub-PDLUT may be generated in accordance with the method 600 described in relation to FIG. 6. At action 1304, the sample sequence may be compensated using the first sub-PDLUT and in accordance with the method 600 described in relation to FIG. 6. At action 1305, a second sub-PDLUT may be generated using the compensated sample sequence and in accordance with the method 600 described in relation to FIG. 6.

At action 1306, the first sub-PDLUT may be transformed into a semi-PDLUT using the improved symmetry operation of the method 700 described in relation to FIG. 7. At action 1307, improved AI unification may be applied to the first sub-PDLUT in accordance with the method 1000 described in relation to FIG. 10.

At action 1308, the second sub-PDLUT may be transformed into a semi-PDLUT using the improved symmetry operation of the method 700 described in relation to FIG. 7. At action 1309, any unknown compensations of the second sub-PDLUT may be determined using at least parts of the method 1000 described in relation to FIG. 10. At action 1310, the second sub-PDLUT may be compressed using PCA and in accordance with the method 1200 described in relation to FIG. 12.

Actions 1306 to 1310 of FIG. 13 may constitute actions to simplify the first sub-PDLUT and the second sub-PDLUT. At action 1311, the simplified sub-PDLUTs may be obtained and may be appended to form the optimized PDLUT 113.

Although FIG. 13 shows one method for generating an optimized PDLUT 113, other methods involving combinations of methods described in the present disclosure may still generate improved performance and reduce size. These methods are further considered under the scope of the present disclosure. Table 5 shows the performance and size for PDLUTs 113 generated according to methods using different combinations of simplification, namely improved AI unification as discussed in relation to FIG. 10 and improved PCA compression as discussed in relation to FIG. 12. Table 5 further shows the number of multipliers needed to implement the methods in an electronic processor. The number of base subsets used for improved AI unification and the degree of compression K for improved PCA compression is denoted in brackets for the respective simplification. Each PDLUT 113 in Table 5 has been cascaded using the method discussed in relation to FIG. 6; the first sub-memory length N1 and the second sub-memory length N2 for each PDLUT 113 is indicated. For N1=3, N2=3, and L=8, the method described in relation to FIG. 13 leads to a PDLUT with a size of 176, the use of two multipliers, and a BER of 0.0038697.

| | | | First sub-PDLUT | Second sub-PDLUT | | | |
|---|---|---|---|---|---|---|---|
| N1 | N2 | L | Simplification | Simplification | Size | Multipliers | BER |
| 3 | 2 | 8 | None | None | 576 | 0 | 0.0040218 |
| | | | AI unification (8) | None | 160 | 1 | 0.0040901 |
| 3 | 3 | 8 | None | None | 1024 | 0 | 0.0037771 |
| | | | AI unification (8) | AI unification (8) | 256 | 2 | 0.0038544 |
| | | | PCA compress. (3) | PCA compress. (1) | 176 | 4 | 0.0038140 |
| | | | AI unification (8) | PCA compress. (1) | 176 | 2 | 0.0038697 |
| 3 | 3 | 10 | None | None | 2000 | 0 | 0.0036228 |
| | | | AI unification (9) | PCA compress. (1) | 320 | 2 | 0.0037293 |
| 3 | 3 | 12 | None | None | 3456 | 0 | 0.0035514 |
| | | | AI unification (8) | PCA compress. (1) | 416 | 2 | 0.0036700 |
| 3 | 3 | 14 | None | None | 5488 | 0 | 0.0035025 |
| | | | AI unification (9) | PCA compress. (1) | 544 | 2 | 0.0036073 |

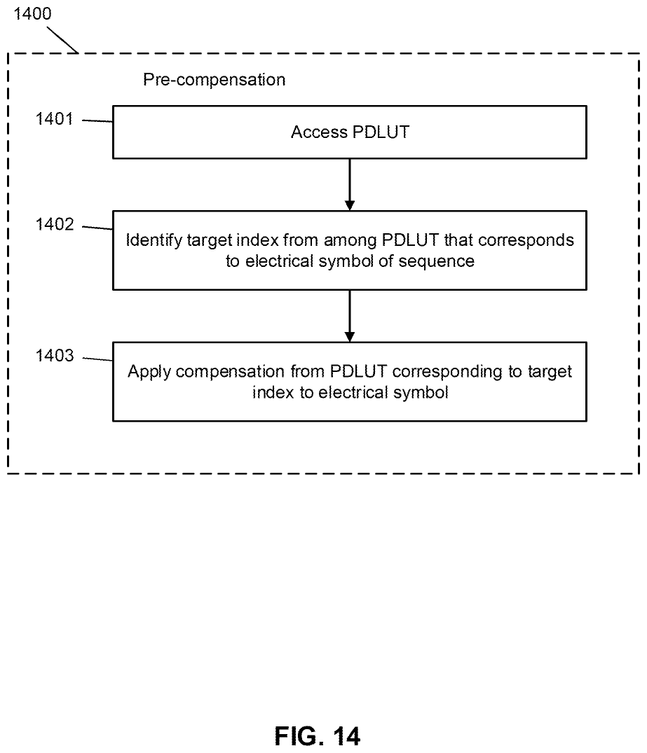

FIG. 14 shows a flowchart of a method 1400 for pre-compensation of electrical symbols of an electrical signal for transmission, in accordance with embodiments of the present disclosure. At action 1401, a PDLUT 113 generated or compressed according to a method of the present disclosure may be accessed. The PDLUT 113 may have been generated or compressed by, for example, one of the methods discussed in relation to at least one of FIGS. 6 to 13. At action 1402, for each electrical symbol, a respective target index from among the indices 302 of the PDLUT 113 may be identified that corresponds to the symbol pattern associated with the respective electrical symbol. At action 1403, the compensation 301 corresponding to the respective target index for each electrical symbol may be applied to that same electrical symbol to pre-compensate it. In some embodiments, a target index may be identified for each of a first sub-PDLUT and a second sub-PDLUT and corresponding compensations may be applied.

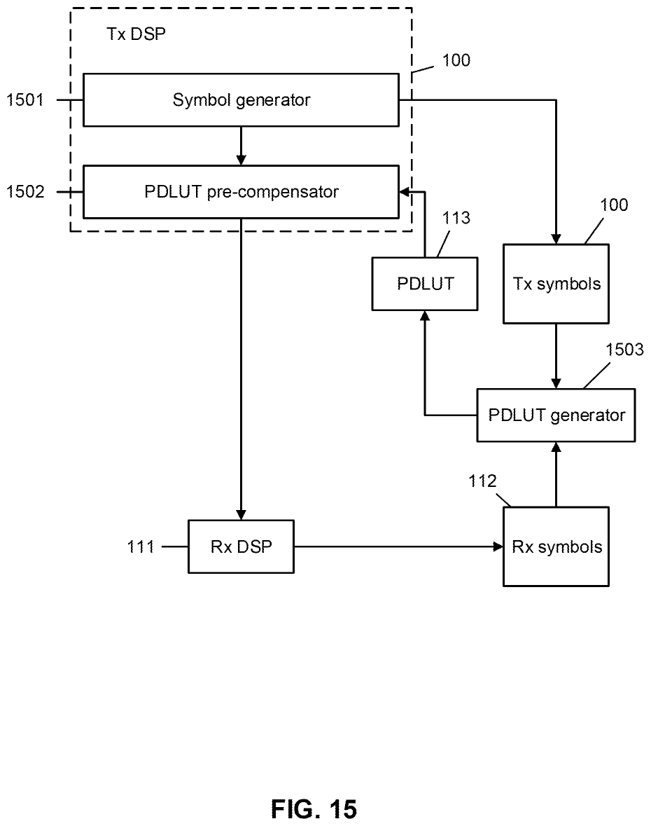

FIG. 15 shows a schematic of a system for PDLUT generation and pre-compensation in accordance with embodiments of the present disclosure. The system comprises a transmitter DSP, which may include a symbol generator 1501 and a PDLUT pre-compensator 1502. The symbol generator 1501 may be used for generating a sequence of transmission symbols 101. The PDLUT pre-compensator may be configured to execute the method described in relation to FIG. 14. The system may further comprise a receiver DSP 111 and a PDLUT generator 1503. The receiver DSP 111 may be configured to extract a sample sequence of received symbols 112 from a received transmission. The PDLUT generator 1503 may be configured to generate a PDLUT 113 from the sample sequence and the sequence of transmission symbols 101 in accordance with, for example, one of the methods discussed in relation to at least one of FIGS. 6 to 13. The PDLUT generator 1503 may further be configured to compress a PDLUT 113.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

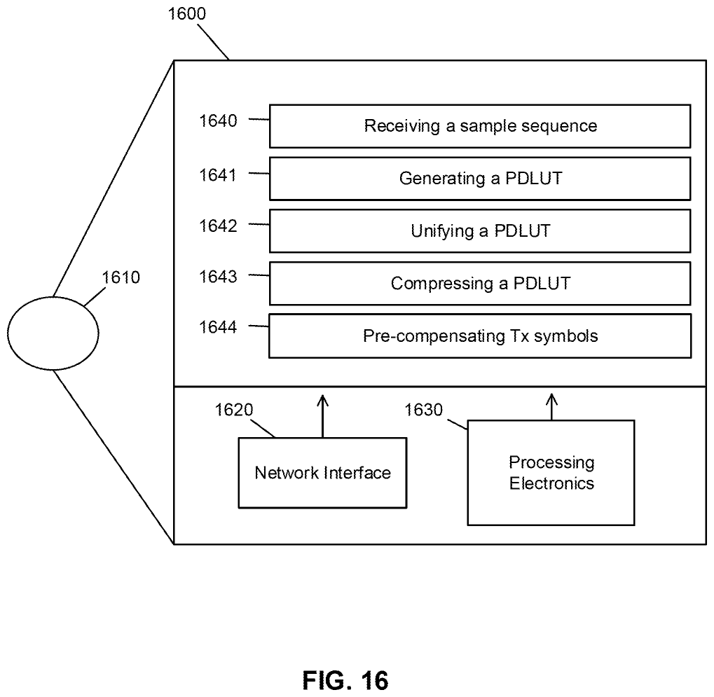

FIG. 16 shows an apparatus 1600 for generating, compressing, or applying a PDLUT 113, according to embodiments of the present invention. The apparatus may be located at a node 610 of the network. The apparatus may include a network interface 620 and processing electronics 630. The processing electronics 630 may include a computer processer executing program instructions stored in memory, or other electronics components such as digital circuitry, including for example FPGAs and ASICs. The network interface 620 may include an optical communication interface or radio communication interface, such as a transmitter and receiver. The apparatus may include several functional components, each of which may be partially or fully implemented using the underlying network interface 620 and processing electronics 630. Examples of functional components may include modules for receiving 1640 a sample sequence, generating 1641 a PDLUT, unifying 1642 a PDLUT, compressing 1643 a PDLUT, and pre-compensating 1644 transmission symbols.

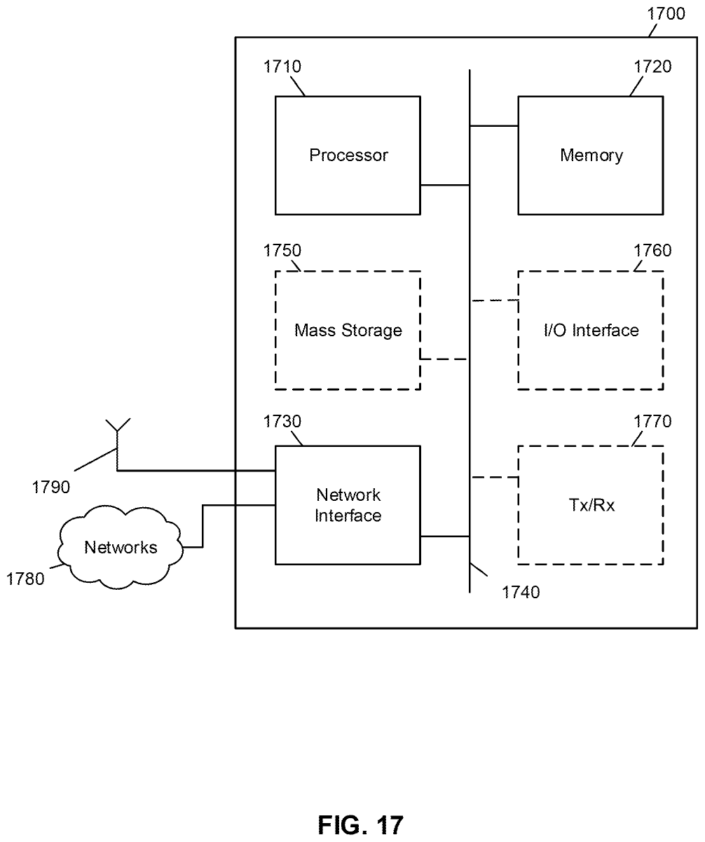

FIG. 17 shows a schematic diagram of an electronic device 1700 that may perform any or all of the operations of the above methods and features explicitly or implicitly described herein, according to different embodiments of the present disclosure. For example, a computer equipped with network function may be configured as electronic device 1700. The electronic device 1700 may be used to implement the apparatus 1600 of FIG. 16, for example. The electronic device 1700 may further be used as part of a Tx DSP 100, an Rx DSP 111, a symbol generator 1501, a PDLUT pre-compensator 1502, and a PDLUT generator 1503, for example.

As shown, the electronic device 1700 may include a processor 1710, such as a Central Processing Unit (CPU) or specialized processors such as a Graphics Processing Unit (GPU) or other such processor unit, memory 1720, network interface 1730, and a bi-directional bus 1740 to communicatively couple the components of electronic device 1700. Electronic device 1700 may also optionally include non-transitory mass storage 1750, an I/O interface 1760, and a transceiver 1770. According to certain embodiments, any or all of the depicted elements may be utilized, or only a subset of the elements. Further, the electronic device 1700 may contain multiple instances of certain elements, such as multiple processors, memories, or transceivers. Also, elements of the hardware device may be directly coupled to other elements without the bi-directional bus 1740. Additionally or alternatively to a processor and memory, other electronics, such as integrated circuits, may be employed for performing the required logical operations.

The memory 1720 may include any type of tangible, non-transitory memory such as static random access memory (SRAM), dynamic random access memory (DRAM), synchronous DRAM (SDRAM), read-only memory (ROM), any combination of such, or the like. The mass storage element 1750 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1720 or mass storage 1750 may have recorded thereon statements and instructions executable by the processor 1710 for performing any of the aforementioned method operations described above.

Network interface 1730 may include at least one of a wired network interface and a wireless network interface. The network interface 1730 may include a wired network interface to connect to a communication network 1780 and may also include a radio access network interface 1790 for connecting to the communication network 1780 or other network elements over a radio link. The network interface 1730 enables the electronic device 1700 to communicate with remote entities such as those connected to the communication network 1780. The network interface 1730 may enable the device 1700 to receive and send transmissions of symbol sequences.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for generating a pattern-dependent look-up table (PDLUT), the method comprising, at a computing device including a processor coupled to tangible, non-transitory processor-readable memory:
receiving a sample sequence comprising a plurality of sample symbols (SMBLs) and defining for each SMBL a respective series of X SMBLs, each series of X SMBLs having a first end SMBL and a second end SMBL, each series of X SMBLs further having a first sub-series of Y SMBLs extending from the first end SMBL toward the second end SMBL and a second sub-series of Z SMBLs extending from the second end SMBL toward the first end SMBL, X, Y, and Z being whole numbers with Y and Z adding to X plus one;
generating a first sub-PDLUT having a respective plurality of indices and defining for each index of the respective plurality of indices a corresponding compensation, the first sub-PDLUT generated by:
detecting, for each series of X SMBLs of the sample sequence, a respective first pattern error depending from the corresponding first sub-series of Y SMBLs, all the first pattern errors defining a plurality of first pattern errors; and
determining, for each index of the first sub-PDLUT, the corresponding compensation in accordance with the plurality of first pattern errors;
compensating, in accordance with the first sub-PDLUT, the plurality of SMBLs of the sample sequence;
generating a second sub-PDLUT having a respective plurality of indices and defining for each index of the respective plurality of indices a corresponding compensation, the second sub-PDLUT generated by:
detecting, for each series of X compensated SMBLs of the compensated sample sequence, a respective second pattern error depending from the corresponding second sub-series of Z compensated SMBLs, all the second pattern errors defining a plurality of second pattern errors; and
determining, for each index of the second sub-PDLUT, the corresponding compensation in accordance with the plurality of second pattern errors; and
appending the first sub-PDLUT and the second sub-PDLUT to form the PDLUT.

2. The method of claim 1 wherein:
each first pattern error corresponds to one of a first plurality of symbol patterns;
the method further comprises:
determining, for each symbol pattern of the first plurality of symbol patterns, a respective error sum and a respective error count each depending from the plurality of first pattern errors, all the error sums of the plurality of first pattern errors defining a first distribution of error sums, all the error counts of the plurality of first pattern errors defining a first distribution of error counts;
identifying a first symmetry defining, for each of the first distribution of error sums and the distribution of first error counts, a first half and a second half;
inverting additively one of the first half and the second half of the first distribution of error sums;
and
summing, in accordance with the first symmetry:
the first half and the second half of the first distribution of error sums to produce a first reduced distribution of error sums,
and
the first half and the second half of the first distribution of error counts to produce a first reduced distribution of error counts;
and
determining, for each index of the first sub-PDLUT, the corresponding compensation in accordance with the plurality of first pattern errors includes:
determining, for each index of the first sub-PDLUT, the corresponding compensation in accordance with the first reduced distribution of error sums and the first reduced distribution of error counts.

3. The method of claim 2 wherein:
each second pattern error corresponds to one of a second plurality of symbol patterns;
the method further comprises:
determining, for each symbol pattern of the second plurality of symbol patterns, a respective error sum and a respective error count each depending from the plurality of second pattern errors, all the error sums of the plurality of second pattern errors defining a second distribution of error sums, all the error counts of the plurality of second pattern errors defining a second distribution of error counts;
identifying a second symmetry defining, for each of the second distribution of error sums and the distribution of second error counts, a first half and a second half;
inverting additively one of the first half and the second half of the second distribution of error sums;
and
summing, in accordance with the second symmetry:
the first half and the second half of the second distribution of error sums to produce a second reduced distribution of error sums,
and
the first half and the second half of the second distribution of error counts to produce a second reduced distribution of error counts;
and
determining, for each index of the second sub-PDLUT, the corresponding compensation in accordance with the plurality of second pattern errors includes:
determining, for each index of the second sub-PDLUT, the corresponding compensation in accordance with the second reduced distribution of error sums and the second reduced distribution of error counts.

4. The method of claim 3 further comprising, for each of the first sub-PDLUT and the second sub-PDLUT:
grouping the respective plurality of indices and the corresponding compensations into a respective plurality of subsets;
categorizing each subset of the respective plurality of subsets as one of a complete subset and an incomplete subset, all the compensations of each complete subset being known, at least one compensation of each incomplete subset being unknown, all the complete subsets of the respective PDLUT defining a respective one or more complete subsets, all the incomplete subsets of the respective PDLUT defining a respective one or more incomplete subsets;
determining a respective one or more base subsets in accordance with the respective one or more complete subsets;
selecting, for each incomplete subset of the respective one or more incomplete subsets, a respective closest base subset from the one or more base subsets of the respective PDLUT;
and
determining, for each incomplete subset of the respective one or more incomplete subsets, each of the at least one unknown compensations in accordance with the respective closest base subset to complete the respective incomplete subset.

5. The method of claim 4 further comprising, for at least one of the first sub-PDLUT and the second sub-PDLUT:
selecting, for each complete subset of the respective one or more complete subsets, a respective closest base subset;
determining, for each subset of the respective plurality of subsets, a respective one or more mapping coefficients to map the respective subset to the respective closest base subset; and
representing the respective PDLUT by the respective mapping coefficients of each subset of the respective plurality of subsets and the respective one or more base subsets.

6. The method of claim 4 further comprising, for at least one of the first sub-PDLUT and the second sub-PDLUT:
determining, for the respective PDLUT and in accordance with principal component analysis, a respective factor scores matrix, a respective right singular matrix, and a respective mean value array each depending from the respective PDLUT;
and
representing the respective PDLUT by the respective factor scores matrix, the respective right singular matrix, and the respective mean value array.

7. The method of claim 1 further comprising:
determining, for each series of X SMBLs of the sample sequence, a respective full pattern error depending from the respective series of X SMBLs, all the full pattern errors defining a plurality of full pattern errors;
organizing the plurality of full pattern errors into a full error distribution having associated thereto a full distribution mean;
removing one or more full pattern errors of the plurality of full pattern errors from the full error distribution to form a clipped error distribution, the one or more full pattern errors being further than a clipping factor from the full distribution mean;
and
determining:
a quantization level in accordance with the clipped error distribution, and,
for each of the first sub-PDLUT and the second sub-PDLUT, the respective plurality of indices in accordance with the quantization level.

8. The method of claim 1 wherein:
the method further comprises receiving a true symbol sequence comprising a plurality of true symbols;
each SMBL of the plurality of SMBLs corresponds to a respective true symbol of the plurality of true symbols;
each first pattern error of the plurality of first pattern errors depends from a difference between the respective series of Y SMBLs and a respective series of Y true symbols, the respective series of Y true symbols corresponding to the respective series of Y SMBLs;
and
each second pattern error of the plurality of second pattern errors depends from a difference between the respective series of Z compensated SMBLs and a respective series of Z true symbols, the respective series of Z true symbols corresponding to the respective series of Z compensated SMBLs.

9. A method for generating a pattern-dependent look-up table (PDLUT) having a plurality of indices and defining for each index of the plurality of indices a corresponding compensation, the method comprising, at a computing device including a processor coupled to tangible, non-transitory processor-readable memory:
receiving a plurality of pattern errors each corresponding to one of a plurality of symbol patterns;
determining, for each symbol pattern of the plurality of symbol patterns, a respective error sum and a respective error count each depending from the plurality of pattern errors, all the error sums defining a distribution of error sums, all the error counts defining a distribution of error counts;
identifying a symmetry defining, for each of the distribution of error sums and the distribution of error counts, a first half and a second half;
inverting additively one of the first half and the second half of the distribution of error sums;
summing, in accordance with the symmetry:
the first half and the second half of the distribution of error sums to produce a reduced distribution of error sums,
and
the first half and the second half of the distribution of error counts to produce a reduced distribution of error counts;
and
determining, for each index of the plurality of indices, the corresponding compensation in accordance with the reduced distribution of error sums and the reduced distribution of error counts.

10. The method of claim 9 wherein the symmetry is a midline of the distribution of error sums and the distribution of error counts.

11. The method of claim 9 wherein determining, for each symbol pattern of the plurality of symbol patterns, the respective error sum and the respective error count each depending from the plurality of pattern errors includes:
summing, for each symbol pattern of the plurality of symbol patterns, the corresponding pattern errors of the plurality of pattern errors to produce the respective error sum;
and
counting, for each symbol pattern of the plurality of symbol patterns, the corresponding pattern errors of the plurality of pattern errors to produce the respective error count.

12. A method for generating a pattern-dependent look-up table (PDLUT) having a plurality of indices and defining for each index of the plurality of indices a corresponding compensation, the method comprising, at a computing device including a processor coupled to tangible, non-transitory processor-readable memory:
receiving a plurality of pattern errors;
determining, for each index of the plurality of indices, the corresponding compensation in accordance with the plurality of pattern errors;
grouping the plurality of indices and the corresponding compensations into a plurality of subsets;
categorizing each subset of the plurality of subsets as one of a complete subset and an incomplete subset, all the compensations of each complete subset being known, at least one compensation of each incomplete subset being unknown, all the complete subsets defining a one or more complete subsets, all the incomplete subsets defining a one or more incomplete subsets;
determining one or more base subsets in accordance with the one or more complete subsets;
selecting, for each of the one or more incomplete subsets, a respective closest base subset from the one or more base subsets;
and
determining, for each of the one or more incomplete subsets, each of the at least one unknown compensations in accordance with the respective closest base subset to complete the respective incomplete subset.

13. The method of claim 12 further comprising:
selecting, for each of the one or more complete subsets, a respective closest base subset;
and
determining, for each subset of the plurality of subsets, a respective one or more mapping coefficients to map the respective subset to the respective closest base subset.

14. The method of claim 13 wherein, for each subset of the plurality of subsets, the respective one or more mapping coefficients is a respective scaling coefficient and a respective translation coefficient.

15. The method of claim 13 wherein, for each subset of the plurality of subsets, the respective one or more mapping coefficients are determined using a linear regression technique.

16. The method of claim 12 wherein the one or more base subsets are determined using a linear regression technique.

17. The method of claim 12 wherein:
the PDLUT has associated thereto a quantization level;
and
grouping the plurality of indices and the corresponding compensations into the plurality of subsets results in each subset of the plurality of subsets having grouped therein a number of compensations, the number of compensations corresponding to the quantization level.

18. The method of claim 12 wherein:
the method further comprises grouping the one or more complete subsets into a plurality of base groups;
and
determining the one or more base subsets in accordance with the one or more complete subsets includes determining, for each base group, a respective average of the complete subsets grouped therein.

19. The method of claim 12 further comprising:
compressing the PDLUT in accordance with principal component analysis to obtain a factor scores matrix, a right singular matrix, and a mean value array each depending from the PDLUT.
